(19) United States
(12) Patent Application Publication
(10) Pub. No.: US 2026/0113538 A1
(43) Pub. Date: Apr. 23, 2026

(54) Real-time Autofocus System

(71) Applicant: SD OPTICS, INC., SEOUL (KR)

(72) Inventors: GYOUNG IL CHO, SEOUL (KR); KYUNG PYO HONG, SEOUL (KR); MIN BEOM LEE, Seoul (KR); CHEONG SOO SEO, Seoul (KR)

(21) Appl. No.: 18/924,943

(22) Filed: Oct. 23, 2024

(51) Int. Cl. H04N 23/67; H04N 23/55

(52) U.S. Cl. CPC H04N 23/671; H04N 23/55

(57) ABSTRACT

The present invention relates to a real-time autofocus system comprising a variable focus imaging system and a laser distance sensor. The variable focus imaging system comprises an objective lens, a band pass filter, a variable focus lens and a camera. The distance between the object and the variable focus imaging system is measured by a laser distance sensor, and the distance information obtained from the laser distance sensor is transmitted to the variable focus lens, enabling real-time auto-focus. To achieve real-time autofocus, the measurement position of the laser distance sensor is configured to be located within the field of view of the variable focus imaging system.

The real-time autofocus system includes a camera configured to receive a light from an object, an objective lens configured to focus a light from an object to the camera, a laser distance sensor configured to measure the distance between an object and the variable focus imaging system, and a variable focus lens to adjust a focus responsively to the measured distance by the laser distance sensor. The variable focus imaging system includes an objective lens configured to forms an image of an object and a band-pass filter configured to prevent the light from the laser distance sensor from entering the camera while allowing the illumination light to pass through to the camera. If variable focus lens is reflected type lens like Micromirror Array Lens (MMAL), the variable focus imaging system further includes a polarized beam splitter configured to transmit P-polarized light and reflect S-polarized light and a quarter wave plate configured to change P-polarized light into S-polarized light when the light goes through the quarter wave plate twice to increase optical efficiency. If the real-time autofocus system is beyond the variable focus range, it can be combined with a Z-axis motor to extend the variable focus range.

### STATEMENT OF GOVERNMENT SUPPORT

This work was supported by the Industrial Technology Innovation Program (20023508, Development of ultra-fast variable focus inspection tool for membrane surface defect inspection for EUV pellicle quality evaluation) funded by the Ministry of Trade, Industry & Energy (MOTIE, Korea).

### FIELD OF THE INVENTION

The present invention relates to a real-time autofocus system, and more particularly, to a real-time autofocus system comprising a laser distance sensor for measuring a distance to an object in real-time and a variable focus imaging system including a variable focus lens for automatically focusing on an object located at the measured distance.

### BACKGROUND OF THE INVENTION

In order to secure market competitiveness in the fields of memory semiconductors and system semiconductors, the foundry industry is striving to gain a technological advantage in sub-3 nm ultra-fine process technology. Furthermore, the semiconductor industry has recently unveiled process roadmaps targeting the 1.x nm level (nanometer, one billionth of a meter).

To satisfy these ultra-fine processes, extreme ultraviolet (EUV) technology must be applied to the process. EUV technology reflects extreme ultraviolet light with a wavelength of 13.5 nm to perform the lithography process, which can improve the resolution and increase the performance of semiconductor circuits. These EUV processes require expensive reflective EUV photomasks and EUV pellicles to protect them. The EUV pellicle has a thickness of less than 30 nm, making it significantly thinner than conventional DUV pellicles. EUV pellicle size of 110×144 mm² represents a very large area relative to its thickness. If defects such as particles are present in such a pellicle, they can cause errors in pattern formation. Therefore, it is essential to inspect the pellicle for contaminants.

In an EUV pellicle, the size of the contaminant particles that need to be detected is around 1.0 μm, and the depth of focus of the optical system used to inspect this is typically in the range of a few micrometers. However, as previously mentioned, the pellicle is extremely thin, with a thickness of just a few tens of nanometers, and has a relatively large surface area. Therefore, severe sag and vibration can occur during the inspection process due to stage movement or internal air flow within the equipment. This sag and vibration of the pellicle causes out of focus. Although an automatic focus can be implemented using a Z-axis motor typically used for focus distance correction, there are limitations in actuation speed when dealing with sag and vibration of the pellicle. Therefore, to inspect contaminants or defects on rapidly vibrating objects, an ultra-fast variable focus lens with a very high response speed is essential. Additionally, since accurately and rapidly measuring the position (height) of a rapidly vibrating object is essential for achieving proper focus, a high-speed sensor is required for this purpose.

### SUMMARY OF THE INVENTION

The present invention relates to a real-time autofocus system comprising a laser distance sensor and a variable focus imaging system including an objective lens, a band pass filter, a polarizing beam splitter (PBS), a quarter wave plate (QWP), a variable focus lens, and a camera. The laser distance sensor measures a distance between an object and the variable focus imaging system and the variable focus imaging system changes the focus using distance information obtained from a laser distance sensor to obtain a focused image.

In the case of conventional objective lenses, the focus position is fixed. Therefore, when dealing with objects whose surface height changes rapidly, there is a limit to achieving proper focus without physical adjustment. To overcome this, a variable focus lens can be used to actively adjust the focus. There are various types of variable focus lenses, but reflective type micromirror array lens (MMAL) and refractive type liquid lens have advantages in terms of response speed and space efficiency.

Methods for measuring distance to an object for autofocus include contrast detection, phase detection, dual-pixel technology, and laser-based approaches, of which laser-based methods offer the greatest advantages in terms of measurement accuracy and response speed. When using a laser distance sensor, the measurement position of the laser distance sensor must be within the field of view (FOV) of the imaging system. If the measurement position of the laser distance sensor is outside the FOV of the optical system, there may be a height difference between the inside and outside of the FOV in the case of objects with surface irregularities or sagging, which may cause a height difference between the FOV and the laser distance sensor measurement position. This height difference interferes with accurate focusing. Therefore, the measurement position of the laser distance sensor must be within the FOV of the imaging system.

The variable focus imaging system consist of an objective lens, a band pass filter, a polarizing beam splitter (PBS), a quarter wave plate (QWP), a variable focus lens, and a camera. The objective lens is used to magnify the image of the object and form a high-resolution image in the camera. The band pass filter is used to pass only light of a certain wavelength while blocking other wavelengths. Since the laser light of the laser distance sensor is projected within the field of view (FOV) of the variable focus imaging system, the band pass filter should prevent the laser light reflected from the object from entering the camera. The tube lens projects the intermediate image formed by the objective lens onto the camera, thereby aiding in the image formation in the overall imaging system. However, the tube lens is only used for infinity-corrected objectives and may not be required for other types of objectives depending on the design.

The light from an illuminator enters the PBS and only the S-polarized light is reflected toward the objective lens for a coaxial illumination. At this time, the light e efficiency drops to 50%. The incident S-polarized light passes through the QWP once, is reflected by the object, and passes through the QWP again, and the S-polarized light is changed to a P-polarized light by the QWP. The P-polarized light passes through the PBS without a decrease in light efficiency and reaches the camera. It is possible to achieve a light efficiency of 50% by using a PBS and QWP. A non-polarized beam splitter (NPBS) loses 50% of its efficiency each time the light passes through it. The light has to pass through the NPBS twice, so the efficiency is 25% (0.5×0.5=0.25) if the NPBS is used.

The variable focus imaging system can use a reflective type variable focusing lens such as micromirror array lens (MMAL). The light from the illuminator enters the 1^{st} PBS and only the S-polarized light is reflected toward the objective lens. At this time, the light efficiency drops to 50%. The incident S-polarized light passes through the 1^{st} QWP once, is reflected by the object, and passes through the 1^{st} QWP again, and the S-polarized light is changed to a P-polarized light by the 1^{st} QWP. The P-polarized light passes through the 2nd QWP once, is reflected by the reflective type variable focus lens, and passes through the 2^{nd} QWP again, and the P-polarized light is changed to a S-polarized light by the 2nd QWP. The S-polarized light reflected by 2^{nd} PBS without a decrease in light efficiency and reaches the camera. It is possible to achieve a light efficiency of 50% by using two PBSs and two QWPs for the reflective-type variable focusing system. A NPBS loses 50% of its efficiency each time the light passes through it. In this configuration, the light has to pass through the NPBS 4 times, so the efficiency is 6.25% (0.5×0.5×0.5×0.5=0.0625) if the NPBS is used.

The laser distance sensor consists of an emitter and a receiver. The emitter is composed of a laser diode, a driver circuit, and a beam-forming lens, which together generate and emit the laser light. The receiver is comprised of a photodetector, an optical lens, and a signal processing circuit, which detect the light reflected from the target object. Structurally, the emitter and receiver are positioned on either side of the objective lens of the imaging system, with the objective lens centrally located. This arrangement ensures that the laser measurement position is located within the field of view of the imaging system.

When the surface c irregularities or vibration amplitude of the target object exceed the focus range of the variable focus lens, the focus range can be adjusted using a Z-axis motor. The autofocus imaging process is as follows: When the system is powered on for the first time, the emitter of the laser distance sensor projects a laser light onto the target object, and the receiver detects the reflected light to measure the distance between the imaging system and the object in real-time. The measured distance information is transmitted to the variable focus imaging system, which then uses a Z-axis motor to adjust the height of either the target object or the variable focus imaging system. However, due to the limitations in the motor's speed and accuracy, precise focusing may not be achieved, but the object is positioned within the variable focus range of the variable focus lens. After the movement, the laser distance sensor measures the distance between the object and the variable focus imaging system again. The measured distance information is transmitted to the variable focus imaging system, which then adjusts the focus of the variable focus lens. At the precisely and quickly adjusted focus position, images are captured using the camera.

### DESCRIPTION OF FIGURES

These and other features, aspects and advantages of the present invention will become better understood with reference to the accompanying drawings, wherein FIG. 1 A configuration for a real-time autofocus system, including a laser distance sensor and a refractive variable focus lens;

FIG. 2 A configuration for a real-time autofocus system, including a laser distance sensor and a reflective variable focus lens;

FIG. 3 A configuration for comparing cases where the laser distance sensor measurement location exists within the FOV of a variable focus optical system and cases where it exists outside the FOV;

FIG. 4 An illustration of extending focus range of a variable focus optical system using a Z-axis motor;

FIG. 5 A method in a real-time autofocus system using a variable focus lens and Z-axis motor

### DETAILED DESCRIPTION OF THE ILLUSTRATED EMBODIMENTS

FIG. 1 illustrates the configuration of a real-time autofocus system, which includes an objective lens 100, a refractive variable focus lens 101, and a laser distance sensor 102, 103. The laser distance sensor, configured to measure the distance 104 between the object and the objective lens 100, comprises an emitter 102 for projecting laser light onto the object and a receiver 103 for detecting the light reflected from the object. The emitter 102 and the receiver 103 are positioned on opposite sides of the objective lens 100, with the objective lens 100 centered between them, so that the laser projection point of the laser distance sensor 102, 103 is located within the field of view (FOV) of the optical system. Additional components include an illuminator 105 for projecting light onto the object, a band pass filter 107 configured to prevent laser light 110 from reaching the camera 111, a polarizing beam splitter (PBS) 106 that separates incident light into two orthogonal polarization components based on its polarization state, and a quarter wave plate (QWP) 108 that alters the polarization state of the light by converting linear polarization into circular polarization or vice versa. The light 109 from the illuminator 105 enters the PBS 106 and only the S-polarized light is reflected toward the objective lens 100. At this time, the light efficiency drops to 50%. The incident S-polarized light passes through the QWP 108 once, is reflected by the object, and passes through the QWP 108 again, and the S-polarized light is changed to a P-polarized light by the QWP 108. The P-polarized light passes through the PBS 106 without a decrease in light efficiency and reaches the camera. It is possible to achieve a light efficiency of 50% by using a PBS and QWP. A non-polarized beam splitter(NPBS) loses 50% of its efficiency each time the light passes through it. The light has to pass through the NPBS twice, so the efficiency is 25% (0.5 ×0.5=0.25) if the NPBS is used.

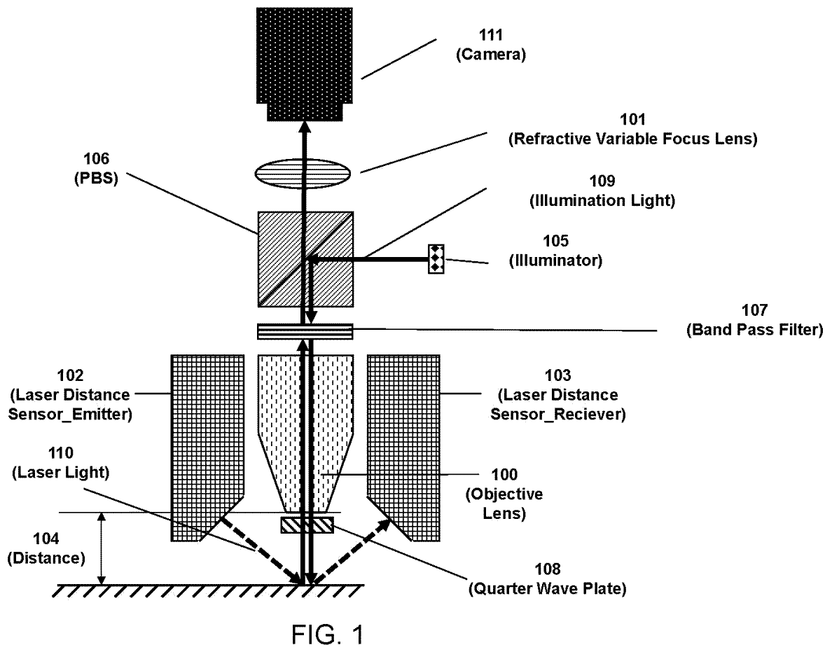

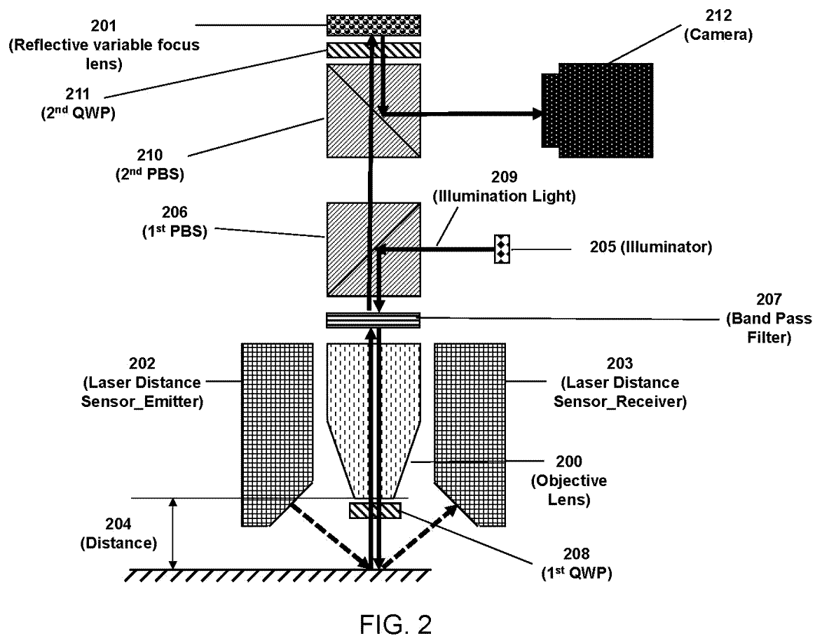

FIG. 2 illustrates the configuration of a real-time autofocus system, which includes an objective lens 200, a reflective type variable focus lens 201, and laser distance sensor 202, 203. The light 209 from the illuminator 205 enters the 1^{st} PBS 206 and only the S-polarized light is reflected toward the objective lens 200. At this time, the light efficiency drops to 50%. The incident S-polarized light passes through the 1^{st} QWP 208 once, is reflected by the object, and passes through the 1^{st} QWP 208 again, and the S-polarized light is changed to a P-polarized light by the 1^{st} QWP 208. The P-polarized light passes through the 2nd QWP 211 once, is reflected by the reflective variable focus lens 201, and passes through the 2^{nd} QWP 211 again, and the P-polarized light is changed to a S-polarized light by the 2nd QWP 211. The S-polarized light reflected by 2^{nd} PBS 210 without a decrease in light efficiency and reaches the camera 212. It is possible to achieve a light efficiency of 50% by using two PBSs and two QWPs. A NPBS loses 50% of its efficiency each time the light passes through it. In this configuration, the light has to pass through the NPBS 4 times, so the efficiency is 6.25% (0.5×0.5×0.5×0.5=0.0625) if the NPBS is used.

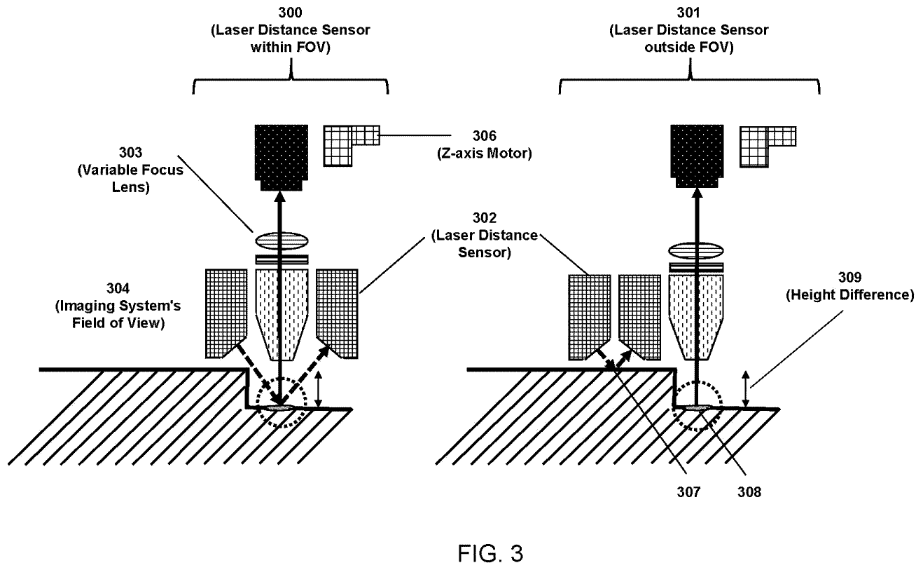

FIG. 3 is a configuration comparing the case where the laser distance sensor measurement position exists within the FOV of the variable optical system 300 and the case where it exists outside the FOV 301. The laser distance sensor 302 measures the distance between the object and the objective lens, enabling the variable focus lens 303 to focus on the object quickly and accurately. When the measurement position of the laser distance sensor 302 is within the FOV 304 of the variable focus imaging system, the height information measured by the laser distance sensor 302 matches the height information of the object to be focused on by the variable focus optical system, so real-time autofocus is possible. When the measurement position of the laser distance sensor 302 is outside the FOV of the variable focus optical system 301, real-time autofocus is not possible because there is a height difference 309 between the measurement position 307 of the laser distance sensor and FOV 308 of the variable focus optical system. Therefore, the measurement position of the laser distance sensor should be inside the FOV of the variable focus optical system

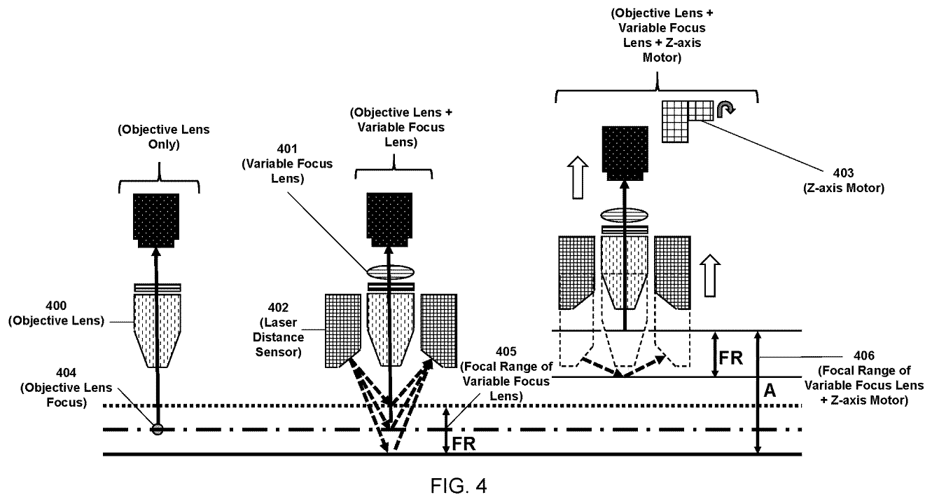

FIG. 4 an illustration of extending the variable focal range of a variable focus optical system using a Z-axis motor. The objective lens 400 has a fixed focal length, which means that the image will be in focus only at a specific position 404. The variable focus lens 401 can actively adjust the focal length of the optical system within a limited range FR 405. To focus an object that is located beyond the variable focus range of a variable focus imaging system, the Z-axis motor 403 must be used to move the object within the variable focus range FR 405. The Z-axis motor 403 increases the focal range of the variable focus optical system 406. If the initially measured distance information from the laser distance sensor 402 is outside the focus range of the variable focus imaging system, the Z-axis motor 403 will operate to adjust the position within the variable focus range FR 405. Once the adjustment is complete, the laser distance sensor 402 measures the distance information a second time, allowing the variable focus imaging system to quickly and accurately focus and capture the image.

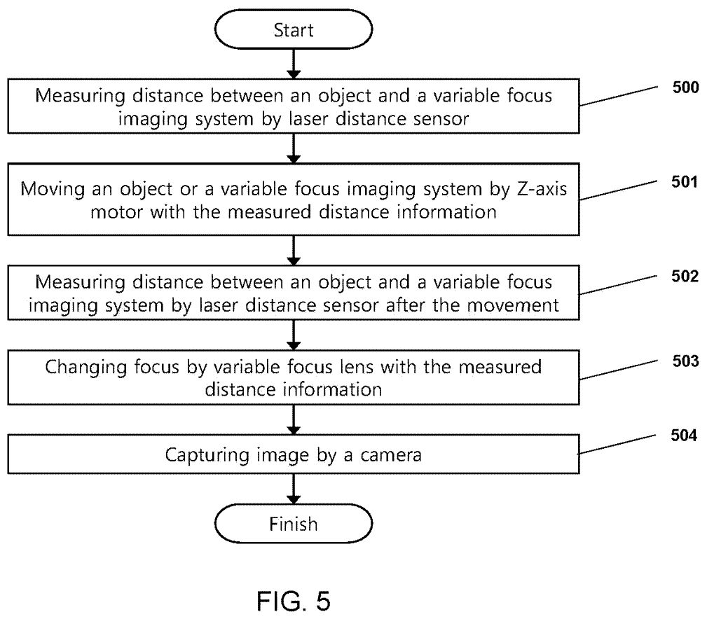

FIG. 5 describes the procedure for obtaining real-time autofocus images using a system that integrates a Z-axis motor with the variable focus imaging system. When the system is powered on for the first time, the emitter of the laser distance sensor projects a laser light onto the target object, and the receiver detects the reflected light to measure the distance between a variable focus imaging system and the object in real-time 500. The measured distance information is transmitted to the variable focus imaging system, which then uses a Z-axis motor to adjust the height of either the target object or the variable focus imaging system 501. However, due to the limitations in the motor's speed and accuracy, precise focusing may not be achieved, but the object can be positioned within the variable focus range of the variable focus lens. After the movement, the laser distance sensor measures the distance between the object and the variable focus imaging system again 502. The measured distance information is transmitted to the variable focus imaging system, which then adjusts the focus of the variable focus lens 503. At the precisely and quickly adjusted focus position, images are captured using the camera 504.

What is claimed is:

1. A real-time autofocus system, comprising:
a laser distance sensor configured to measure the distance to an object; and
a variable focus imaging system configured to change the focus according to the distance information measured from the laser distance sensor and capture a focused image, wherein the variable focus imaging system, comprising:
an objective lens;
a variable focus lens configured to change shape to focus on the object;
a camera; and
a band pass filter configured to prevent the light from the laser distance sensor from entering the camera while allowing the light from an illuminator light to pass through to the camera.

2. The real-time autofocus system according to claim 1, wherein the laser distance sensor comprises an emitter and a receiver, and the measurement position of the laser distance sensor is located within the field of view of the variable focus imaging system.

3. The real-time autofocus system according to claim 1, further comprising;
a coaxial illuminator;
a polarized beam splitter (PBS) configured to reflect S-polarized light and transmit P-polarized light from the coaxial illuminator, wherein the S-polarized light or the P-polarized light goes through the objective lens;
a quarter wave plate (QWP) configured to change the polarization direction from the objective, such as S-polarized light to P-polarized light or the P-polarized light to S-polarized light, wherein the polarization direction is changed after the light goes through the QWP, is reflected by an object and go through the QWP again.

4. The real-time autofocus system according to claim 1, wherein the variable focus lens is a refractive type liquid lens.

5. The real-time autofocus system according to claim 1, wherein the variable focus lens is a reflective type Micromirror Array Lens (MMAL), wherein the MMAL comprises a plurality of micromirrors.

6. The real-time autofocus system according to claim 5, wherein the variable focus imaging system further comprising;
a polarized beam splitter (PBS) configured to reflect S-polarized light and transmit P-polarized light from the objective lens; and
a quarter wave plate (QWP) configured to change the polarization direction, such as S-polarized light to P-polarized light or the P-polarized light to S-polarized light, wherein the polarization direction is changed after the light goes through the QWP, is reflected by the MMAL and go through the QWP again.

7. The real-time autofocus system according to claim 1, further comprising:
a Z-axis motor configured to move the object or the variable focus imaging system to increase auto-focus range of the real-time autofocus system.

8. A method in a real-time autofocus, comprising:
Step 1: measuring distance between an object and the variable focus imaging system by laser distance sensor;
Step 2: moving an object or the variable focus imaging system to minimize auto-focus range of variable focus lens by Z-axis stage with the measured distance information;
Step 3: measuring distance between an object and a variable focus imaging system by laser distance sensor after the movement;
Step 4: changing focus by variable focus lens with the measured distance information by the laser distance sensor;
Step 5: capturing image by a camera.
